(19) United States
(12) Patent Application Publication
(10) Pub. No.: US 2026/0003911 A1
(43) Pub. Date: Jan. 1, 2026

(54) APPLICATION RECOMMENDATIONS BASED ON OFFLINE DATA TRANSACTIONS

(71) Applicant: Motorola Mobility LLC, Chicago, IL (US)

(72) Inventors: Vijayprakash Idlur, Bangalore (IN); Prasad A G, Bengaluru (IN); Krishnan Raghavan, Bangalore (IN)

(73) Assignee: Motorola Mobility LLC, Chicago, IL (US)

(21) Appl. No.: 18/759,929

(22) Filed: Jun. 30, 2024

(51) Int. Cl. G06F 16/903; G06Q 30/0601

(52) U.S. Cl. CPC G06F 16/90335; G06Q 30/0631; G06Q 30/0641

(57) ABSTRACT

In accordance with the described techniques, a mobile device receives indications of offline data transactions, and the indications include transaction information relating to the offline data transactions. Based on the transaction information, the mobile device detects a product transacted for via the offline data transactions. The mobile device retrieves an application from an application database that supports online data transactions for the product or a similar product that is similar to the product. Furthermore, the mobile device displays a recommendation in a user interface for the application to be downloaded or opened on the mobile device.

### BACKGROUND

Device users have access to a multitude of software applications on their devices that simplify and streamline daily tasks. From productivity tools to entertainment applications, the variety of software applications can enhance various aspects of daily life. Due to the sheer number of software applications available for download, it is often difficult for device users to discover software applications that are tailored to the device user's needs. Navigating through countless software application choices can be overwhelming, leading to user frustration and suboptimal choices. To ease the burden of application discovery for device users, application recommendation functionality is operable to display software applications that are predicted to be useful and/or beneficial for a particular user on the particular user's device.

### BRIEF DESCRIPTION OF THE DRAWINGS

Aspects of application recommendations based on offline data transactions are described with reference to the following Figures. The same numbers may be used throughout to reference similar features and components that are shown in the Figures. Further, identical numbers followed by different letters reference different instances of features and components described herein.

FIG. 1 illustrates an example environment in which application recommendations based on offline data transactions can be implemented;

FIG. 2 illustrates an example system for application recommendations based on offline data transactions;

FIG. 3 depicts an example user interface of a data transaction application showing records of offline data transactions;

FIG. 4 depicts an example user interface of a data transaction application for inputting information regarding an offline data transaction;

FIG. 5 depicts an example user interface displaying application recommendations based on offline data transactions;

FIG. 6 illustrates a flow chart depicting an example method of application recommendations based on offline data transactions in accordance with one or more implementations;

FIG. 7 illustrates various components of an example device in which aspects of application recommendations based on offline data transactions can be implemented in accordance with one or more implementations.

### DETAILED DESCRIPTION

An offline payment transaction is a payment transaction in which two parties (e.g., a buyer and a seller) are present at a same physical location when the transaction is conducted. In other words, offline payment transactions are in-person payment transactions in which the buyer and a representative of the seller are co-located at a brick-and-mortar establishment when the payment transaction is conducted. Offline payment transactions differ from online payment transactions, in which a user initiates a payment transaction via an online payment portal, e.g., provided by a website or an application of an entity offering a good or service transacted for.

Conventional application recommendation functionality tracks online payment transactions conducted by a user of a mobile device, and recommends applications to be downloaded on the mobile device and used by the user based on the online payment transactions. However, due to a lack of readily available transaction information associated with offline payment transactions, conventional application recommendation functionality underutilizes offline payment transactions as a basis for identifying recommended applications that the user is likely to be interested in. Scenarios can occur, therefore, in which a user is unaware of an application that supports online payment transactions for a product (e.g., a good or a service) that the user typically transacts for in-person, and the application can save the user time and/or resources of value.

To alleviate these inconveniences, techniques for application recommendations based on offline data transactions are discussed herein. The described techniques, for instance, can be implemented by an app recommendation system of a mobile device associated with a user. In various implementations, the mobile device is communicatively coupled with a service provider system, e.g., over a network. Furthermore, the mobile device has installed and/or accessible thereon a transaction application, and the user maintains an account on the transaction application. The transaction application is representative of functionality for enabling payment transactions, e.g., between accounts of the transaction application and/or to other payment receival devices and mechanisms, such as point-of-sale devices. Accordingly, the transaction application includes records of offline payment transactions conducted by the user, e.g., transferring amounts of value from the account of the user on the transaction application.

In various implementations, the offline payment transactions include, by default, certain transaction information. An offline payment transaction recorded by the transaction application, for instance, includes an establishment where the offline payment transaction was conducted. Additionally or alternatively, the user provides input via a user interface of the payment application including supplemental transaction information relating to the offline payment transactions. In one or more implementations, for instance, the user provides user input entering keyword tags associated with an offline payment transaction. For example, the keyword tags identify a particular product transacted for (e.g., paper) via the offline payment transaction and/or a category of products (e.g., office supplies) transacted for via the offline payment transaction.

Additionally or alternatively, the user provides user input supplying a transaction document image (e.g., an image of a payment receipt) that includes text describing transaction information associated with offline payment transaction. Here, the transaction information supplied by a transaction document image includes particular products transacted for, quantities of particular products transacted for, and an amount of value (e.g., a portion of the purchase price) attributable to individual products transacted for. In one or more implementations, the app recommendation system extracts this transaction information from the transaction document image using an optical character recognition algorithm and/or a machine learning model (e.g., an object detection model) trained to detect specific components of a payment receipt, e.g., products, quantities of products, amounts of value attributable to individual products, and the like.

Based on the transaction information, the app recommendation system detects a particular product transacted for via the offline payment transactions. As part of this, the service provider system maintains an establishment database, including a plurality of establishments each paired with a corresponding product typically offered by the establishment. In scenarios in which an offline payment transaction solely includes the default transaction information (e.g., the establishment where the transaction was conducted), the app recommendation system detects the particular product transacted for via the offline payment transaction using the establishment database. In particular, the app recommendation system queries the establishment database with an identifier of the establishment, and the establishment database returns the corresponding product paired therewith in the establishment database. In scenarios in which an offline payment transaction includes the supplemental transaction information, the app recommendation system obtains the particular product transacted for from the supplemental transaction information.

In one or more implementations, the app recommendation system additionally detects a tendency of the user to transact for the particular product via the offline payment transactions based on the transaction information. For example, the tendency is detected as a quantity of the particular product transacted for via the offline payment transactions exceeding a quantity threshold, a number of the offline payment transactions that include the particular product during a time period exceeding a frequency threshold, and/or an amount of value of the offline payment transactions that are attributable to the particular product exceeding a value threshold.

The service provider system additionally maintains an application database, including a plurality of entries. Each entry includes an application and one or more products for which the application supports online payment transactions. By way of example, an electrical utility application that supports bill pay can be associated with the product of “utility bills” in the application database. Thus, based on the detected tendency of the user to transact for the particular product via the offline payment transactions, the app recommendation system queries the application database with the particular product, and the application database returns an application paired with the particular product in the application database.

In one or more implementations, the app recommendation system is configured to predict a quantified benefit conferred on the user by transacting for the particular product via the online payment transactions using the application, rather than via the offline payment transactions. For example, the app recommendation system calculates an amount of time the user spends over a time period (e.g., per month) conducting offline payment transactions for a particular product. In a grocery shopping example, the amount of time includes time spent by the user traveling to and from one or more grocery stores and time spent grocery shopping at the one or more grocery stores. Here, the quantified benefit includes the amount of time that the user spends grocery shopping every month that could be saved by downloading and using an application that supports a grocery delivery service.

Moreover, the app recommendation system displays a recommendation in a user interface of the mobile device for the application to be downloaded or opened on the mobile device. In one or more implementations, the recommendation includes an indication of the quantified benefit and a user interface element. In scenarios in which the application is already downloaded on the mobile device, the user interface element is selectable to open the application. In scenarios in which the application is not downloaded on the mobile device, the user interface element is selectable to download the application.

Thus, techniques discussed herein display application recommendations for applications that support online payment transactions for products that a user tends to transact for via offline payment transactions. In implementations, a payment transaction represents a data transaction. For instance, digital payment transactions involve generating, transmitting, and processing various types of data and across a variety of different systems and networks. Accordingly, such digital payment transactions can be characterized as sets of computational operations much like other operations of a computing device and/or set of computing devices.

As previously mentioned, conventional application recommendation technology often utilizes online payment transactions, but not offline payment transactions for making application recommendations. Thus, given a user that exclusively or nearly exclusively conducts payment transactions offline, conventional application recommendation functionality fails to use all or nearly all of the user's transaction history as a basis for making application recommendations. This results in application recommendations that are not tailored to the user's needs. In order to discover applications, therefore, that support products similar to the user's offline transaction history, the user must manually navigate through a multitude of applications made available by a service provider. This process involves numerous network communications between the user's device and the service provider system, e.g., repeatedly entering different keyword searches, selecting and viewing additional information associated with different applications, and so on.

In contrast, the described techniques automatically display recommended applications to a user based on the user's offline payment transaction history. This results in application recommendations that are more likely to fit the user's needs. This conserves network resources (e.g., network bandwidth) by reducing communication exchanges between the user's device and the service provider system during the application discovery process, e.g., the user selects the application from a list of recommended applications rather than manually searching for the application. Moreover, the described techniques improve user satisfaction because the user need not manually search for applications that are specific to the user's offline transaction habits. User satisfaction is further improved because the described techniques surface applications that support online payment transactions for products typically transacted for by the user via offline data transactions. In various scenarios, the recommended applications therefore save the user resources of value (e.g., because the product is cheaper online), and time, e.g., because the user need not travel to a brick-and-mortar establishment to conduct similar transactions in the future.

While features and concepts of application recommendations based on offline data transactions can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

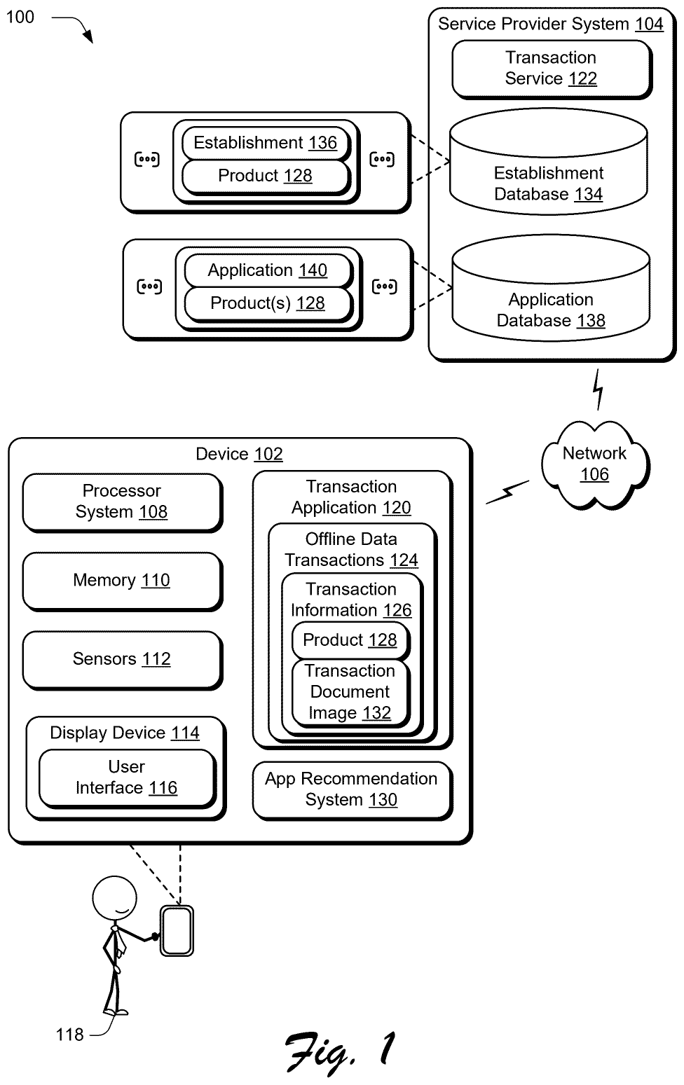

FIG. 1 illustrates an example environment 100 in which aspects of application recommendations based on offline data transactions can be implemented. The environment 100 includes a device 102 and a service provider system 104 that are communicatively coupled over a network 106. Computing devices that implement the device 102 and the service provider system 104 are configurable in a variety of ways. A computing device, for instance, is configurable as a desktop computer, a laptop computer, a mobile device (e.g., assuming a handheld configuration such as a tablet or mobile phone), one or more server devices, and so forth. Thus, a computing device ranges from full resource devices with substantial memory and processor resources (e.g., personal computers, game consoles, server devices) to a low-resource device with limited memory and/or processing resources (e.g., mobile devices). In at least one example, the device 102 is a mobile device (e.g., a smartphone) and the service provider system 104 is implemented by multiple server devices to provide and manage access to digital services that are accessible by the device 102 via the network 106.

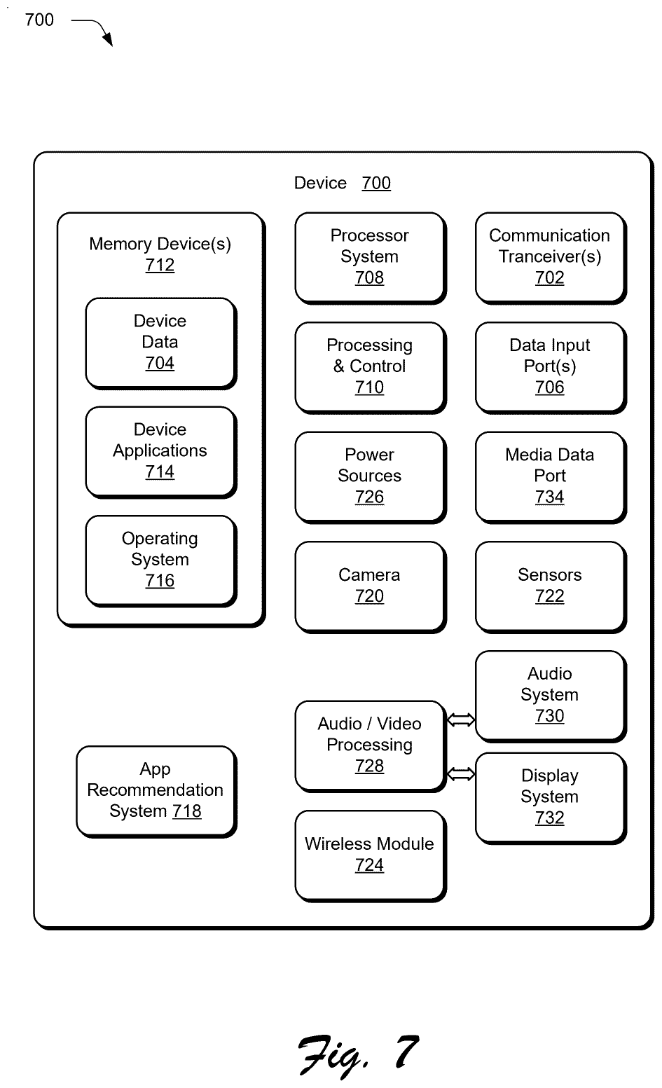

In one or more examples, the device 102 is implemented with various hardware components, such as a processor system 108, memory 110, sensors 112, and a display device 114. Examples of the sensors 112 include, but are not limited to digital cameras, microphones, and global positioning system (GPS) sensors for location tracking. The display device 114 is representative of functionality for output of graphical content via the device 102, e.g., in a user interface 116 of the display device 114. In one or more implementations, the display device 114 additionally includes touch input functionality, such as to enable a user 118 of the device 102 (e.g., an owner and/or a registered user of the device 102) to provide input to the device 102 via touch input to the display device 114. The device 102 and the service provider system 104 are also implemented with any number and any combination of different components, as further discussed below with reference to the example device 700 of FIG. 7.

As shown, the device 102 includes a transaction application 120, which together with a transaction service 122 of the service provider system 104, represents functionality for facilitating payment transactions to and from an account maintained by the user 118 with the transaction service 122. By way of example, the transaction application 120 corresponds to software instructions stored in memory 110 that are executable by the processor system 108 to provide user-facing interfaces and functionality for conducting payment transactions via the device 102. Furthermore, the transaction service 122 provides the backend infrastructure, hardware resources, and/or a network that processes payment transactions, ensuring that payments are authorized and settled correctly. In one or more implementations, the transaction application 120 and/or the transaction service 122 support functionality for sending payment transactions from the account of the user 118 and receiving payment transactions to the account of the user 118, e.g., via other user accounts with the transaction service 122 and/or other payment receival devices and mechanisms, such as point-of-sale devices.

In one or more implementations, the transaction application 120 is made available by a multi-service platform of the service provider system 104. By way of example, the transaction service 122 is implemented, in part, by server devices of the service provider system 104. Moreover, the service provider system 104 includes or corresponds to a multi-service platform including the transaction service 122, and any one or more of a variety of different digital services, e.g., digital marketplace services, content streaming services, gaming services, news and productivity services, and the like. As part of this, the device 102 includes an integrated services application (e.g., also known as a “super app”), and the integrated services application includes the transaction application 120 and/or other service-based applications, e.g., also known as “mini apps.” For instance, the integrated services application and/or the multi-service platform enable a cohesive, personalized user experience across a variety of different digital services by sharing data between different service-based applications that have a common look and feel.

As shown, the transaction application 120 includes a record of offline data transactions 124. In one or more implementations, offline data transactions 124 are payment transactions conducted between two parties (e.g., a seller and a buyer) at a same physical location. Offline data transactions 124, for instance, are in-person payment transactions from the user 118 as the buyer to a seller, such that the user 118 and a representative of the seller are present at a brick-and-mortar establishment when the payment transaction is conducted. Offline data transactions 124 are different from online data transactions by which the user 118 transacts for (e.g., purchases) goods and/or services through an online transaction portal, e.g., provided by a website or application.

In various implementations, the offline data transactions 124 include payment transactions conducted by the user 118 using a variety of payment methods. For instance, the offline data transactions 124 include payment transactions sent from the account of the user 118 with the transaction application 120 and/or transaction service 122. Additionally or alternatively, the offline data transactions 124 include cash payment transactions, the details of which the user 118 has manually entered, via user input, to the transaction application 120.

Additionally or alternatively, the offline data transactions 124 include payment transactions associated with an additional application of the device 102 linked with the transaction application 120. For instance, the device 102 additionally includes a mobile banking application associated with various payment methods, such as credit cards, debit cards, and/or checking accounts. In one or more implementations, the transaction application 120 and the mobile banking application are linked, thereby enabling communication of personal and secure data between the applications. Furthermore, the transaction application 120 receives, from the mobile banking application, offline data transactions 124 conducted using the payment methods associated with the mobile banking application, e.g., debit cards, credit cards, and/or checking accounts.

As shown, the offline data transactions 124 include transaction information 126. In one or more implementations, the transaction information 126 of an offline data transaction 124 includes an indication of an establishment where the offline data transaction 124 was conducted (e.g., a name or identifier of the establishment and/or an address of the establishment), an indication of one or more products 128 (e.g., goods or services) transacted for (e.g., purchased) by the user 118 via the offline data transaction 124, a quantity of the one or more products 128 transacted for via the offline data transaction 124, and/or an amount of data resources (e.g., an amount of value or a portion of the purchase price) attributable to each of the one or more products 128. A product 128 of an offline data transaction 124 is a good or service transacted for via the offline data transaction 124, and the product 128 can correspond to a particular good or service (e.g., paper) or a category of goods or services, e.g., office supplies.

In accordance with the described techniques, the device 102 includes an app recommendation system 130, which is representative of functionality for recommending applications to be opened and/or installed on the device 102 based on the offline data transactions 124. As part of this functionality, the app recommendation system 130 extracts portions of the transaction information 126 of an offline data transaction 124 from a transaction document image 132. The transaction document image 132 of an offline data transaction 124, for instance, is an image of a document (e.g., a payment receipt) that includes text describing the transaction information 126 relating to the offline data transaction 124. By way of example, the user 118 captures an image (e.g., using a camera of the sensors 112) of a payment receipt associated with an offline data transaction 124. Furthermore, the user 118 provides user input (e.g., via a user interface 116 of the transaction application 120) uploading the transaction document image 132 to a record of the offline data transaction 124 maintained by the transaction application 120. In at least one example, the app recommendation system 130 applies an optical character recognition (OCR) algorithm to recognize the text in the transaction document image 132, and extracts the transaction information 126 from the recognized text. Given a transaction document image 132 of a payment receipt, for instance, the app recommendation system extracts the products 128 (e.g., product names and/or identifiers of the products) listed in the payment receipt, quantities of the products 128 listed in the payment receipt, and a purchase amount attributable to individual products 128 in the payment receipt.

In one or more scenarios, a product 128 of an offline data transaction 124 is retrieved from a establishment database 134 maintained by the service provider system 104. As shown, the establishment database 134 includes a plurality of entries each including an identifier of an establishment 136 (e.g., an establishment name or an address of the establishment 136) and a corresponding product 128 typically offered by the establishment 136. In an example in which the establishment 136 is a grocery store, the product 128 paired with the grocery store in the establishment database 134 is “groceries.” Thus, in one or more implementations, the app recommendation system 130 queries the establishment database 134 with the identifier of an establishment 136, and the service provider system 104 returns the product 128 paired with the establishment 136 in the establishment database 134.

In one or more implementations, an offline data transactions 124, by default, is recorded with an identifier of the establishment 136 where the transaction was conducted, but does not, by default, include other, supplemental transaction information 126, e.g., particular products 128 transacted for, quantities of products 128 transacted for, portions of a purchase price attributable to particular products 128, and the like. Thus, by extracting the supplemental transaction information 126 from the transaction document image 132, the record of the offline data transaction 124 includes supplemental transaction information 126 regarding the offline data transaction 124. Moreover, retrieving the product 128 from the establishment database 134 in the manner described enables a product 128 to be associated with an offline data transaction 124 in scenarios in which the user 118 does not upload a transaction document image 132 for the offline data transaction 124.

After having detected a product 128 transacted for via the offline data transactions 124, the app recommendation system 130 identifies an application that supports online data transactions for the detected product 128 or a similar product that is similar to the detected product 128. To do so in one or more implementations, the app recommendation system 130 retrieves the application from an application database 138 maintained by the service provider system 104. As shown, the application database 138 includes a plurality of entries each including an application 140 and one or more products 128 (e.g., goods or services) for which the application 140 supports online data transactions. In an example, an entry of the application database 138 includes a grocery delivery application 140 and a product 128 of “groceries,” indicating that the application 140 supports online data transactions for groceries.

Accordingly, the app recommendation system 130 queries the application database 138 with the product 128 detected as transacted for via the offline data transactions 124. Furthermore, the service provider system 104 searches the application database 138 for the detected product 128 and/or products 128 that are similar to the detected product 128, and returns an application 140 paired with the detected product 128 or a similar product 128 in the application database 138. In addition, the app recommendation system 130 displays a recommendation in the user interface 116 for the application 140 to be downloaded or opened on the device 102. Thus, the described techniques recommend applications to the user 118 that support online data transactions for a product 128 based on the user tending to transact for the product 128 via the offline data transactions 124. By doing so, the described techniques recommend applications that save the user time and effort, e.g., by not having to travel to a brick-and-mortar establishment to conduct the transaction for the product 128.

Having discussed an example environment in which the disclosed techniques can be performed, consider now some example scenarios and implementation details for implementing the disclosed techniques.

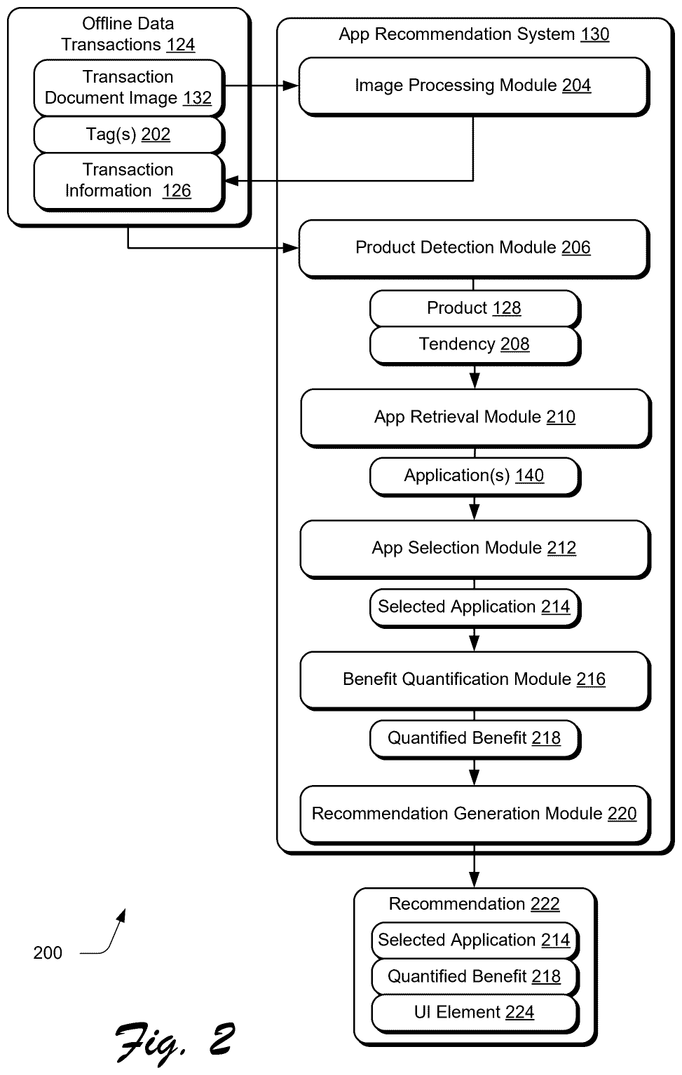

FIG. 2 illustrates an example system 200 for application recommendations based on offline data transactions. As shown, the app recommendation system 130 receives indications of offline data transactions 124, each including transaction information 126. Additionally or alternatively, each offline data transaction 124 includes a transaction document image 132 and/or one or more tags 202. By way of example, the user 118 provides user input uploading, to a record of an offline data transaction 124, a transaction document image 132 (e.g., a payment receipt) including text describing the transaction information 126. Additionally or alternatively, the user 118 provides user input entering one or more tags 202 associated with an offline data transaction 124, e.g., specific products 128 transacted for, categories of products 128 transacted for, budgeting categories to which the offline data transaction 124 is attributable, and so on.

In one or more implementations, one or more portions of the transaction information 126 of an offline data transaction 124 are included, by default, as part of a record of the offline data transaction 124. By way of example, an offline data transaction 124 is recorded in the transaction application 120 with an identifier of an establishment where the transaction was conducted. Additionally or alternatively, one or more portions of the transaction information 126 of an offline data transaction 124 are extracted from the transaction document image 132 and/or the tags 202. For instance, the app recommendation system 130 extracts, from the tags 202, a product 128 transacted for via the offline data transaction 124.

As shown, the app recommendation system 130 includes an image processing module 204, which is representative of functionality for processing a transaction document image 132 of an offline data transaction 124 to extract transaction information 126. As part of this, the image processing module 204 applies an OCR algorithm to recognize text in the transaction document image, and extracts transaction information 126 from the recognized text. In various examples, the extracted transaction information 126 includes one or more products 128 transacted for via the offline data transaction 124, quantities of the one or more products 128 transacted for via the offline data transaction 124, an amount of data resources (e.g., an amount of value or a portion of the purchase price) attributable to each of the one or more products transacted for via the offline data transaction 124.

In one or more implementations, the image processing module 204 includes or corresponds to a machine learning model (e.g., an object detection model) that has been trained to detect specific components of a payment receipt, e.g., products 128 transacted for, quantities of the products 128, purchase price of the payment receipt, portions of the purchase price attributable to individual products 128, and so on. As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, continuous learning, interactive learning, and/or transfer learning. For example, a machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

In one example, the machine learning model is trained on a training dataset to detect specific components of a payment receipt using supervised learning. The training dataset includes training images of payment receipts, and each payment receipt includes ground truth bounding boxes identifying where components of a payment receipt are and ground truth labels identifying types of components (e.g., products, quantities of products, price of products, etc.) identified by the bounding boxes. Given a training image of a payment receipt, the machine learning model is employed to generate predicted bounding boxes predicting where components of the payment receipts are and predicted labels predicting types of components (e.g., products, quantities of products, prices of products, etc.) identified by the predicted bounding boxes. Further, a loss is computed based on distances between the ground truth bounding boxes and corresponding predicted bounding boxes, and whether the predicted labels of the predicted bounding boxes match the ground truth labels of corresponding ground truth bounding boxes. Moreover, parameters (e.g., internal weights) of the machine learning model are updated to reduce the loss. This process is repeated iteratively on different training images until the loss converges to a minimum, a threshold number of training images are processed, or a threshold number of epochs are processed.

Thus, in one or more implementations, the trained machine learning model receives the transaction document image 132 (e.g., a payment receipt), and generates bounding boxes identifying and labeling specific components of the transaction document image 132, e.g., as products 128 transacted for, quantities of the products 128, purchase price of the payment receipt, portions of the purchase price attributable to individual products 128. Furthermore, the image processing module 204 outputs the transaction information 126 based on the recognized text (e.g., as recognized by the OCR algorithm) within or near the bounding boxes. Given a bounding box with a label identifying the bounding box as a particular product 128 transacted for, the image processing module 204 outputs, as a product 128 transacted for via the offline data transaction 124, the recognized text within the bounding box.

As shown, the indications of the offline data transactions 124 are received by a product detection module 206, which is representative of functionality for detecting a product 128 transacted for via the offline data transactions 124 based on the transaction information 126. In one or more implementations, the product detection module 206 detects the product 128 by extracting or retrieving the product 128 directly from the transaction information 126. Additionally or alternatively, the product detection module 206 sends a query to the establishment database 134 including an identifier of an establishment 136 associated with an offline data transaction 124. The service provider system 104 obtains a product 128 paired with the establishment 136 in the establishment database 134, and communicates the product 128 to the product detection module 206. In one or more scenarios, the product detection module 206 detects the product 128 based on the product 128 having been transacted for 128 at least once via the offline data transactions 124.

Additionally or alternatively, the product detection module 206 detects a tendency 208 of the user 118 to consistently transact for the product 128 via the offline data transactions 124 based on the transaction information 126. In various implementations, the product detection module 206 detects, as the tendency 208, a quantity of the product 128 transacted for via the offline data transactions exceeding a quantity threshold. For example, the transaction information 126 indicates that the user 118 has conducted for at least a threshold number of construction equipment products during a one month time period. Additionally or alternatively, the product detection module 206 detects, as the tendency 208, a number of the offline data transactions 124 that include the product 128 during a time period exceeding a frequency threshold. By way of example, the transaction information 126 indicates that the user 118 has conducted at least a threshold number of offline data transactions 124 for construction equipment during a one month time period, e.g., the user 118 has visited a brick-and-mortar construction equipment supplier at least a threshold number of times. Additionally or alternatively, the product detection module 206 detects, as the tendency 208, an amount of data resources (e.g., an amount of value) spent on the product 128 exceeding a data amount threshold, e.g., a value amount threshold. For instance, the transaction information 126 indicates that the user 118 has spent at least a threshold amount of value on construction equipment via the offline data transactions 124 during a one month time period.

Based on the detected product 128 and/or the tendency 208 of the user 118 to transact for the detected product 128, an app retrieval module 210 is configured to retrieve one or more applications 140 from the application database 138 that support online payment transactions for the detected product 128 or a similar product that is similar to the detected product 128. To do so, the app retrieval module 210 sends a query to the service provider system 104 that includes the detected product 128. The service provider system 104 searches the application database 138 for products 128 that exactly match the detected product 128 and products 128 that are similar to the detected product 128. Furthermore, the service provider system 104 obtains one or more applications 140 paired with the detected product 128 or a similar product 128 in the application database 138, and communicates the one or more applications 140 to the app retrieval module 210. In one or more scenarios, the similar product 128 is a category of products 128 that the detected product 128 falls under. For example, the detected product 128 is produce (e.g., fruits and vegetables) which is a sub-category of groceries, and as such, the app retrieval module 210 retrieves an application 140 that offers online transactions for produce specifically and/or an application 140 that offers online transactions for groceries generally.

As shown, the one or more applications 140 are provided as input to an app selection module 212. In scenarios in which multiple applications 140 are retrieved by the app retrieval module 210, the app selection module 212 selects a particular application 140 (e.g., the selected application 214) from the multiple applications 140. In one or more implementations, the selection is based on a degree of similarity between the product 128 that is detected as transacted for via the offline data transactions 124 and the products 128 for which the retrieved applications 140 support online data transactions. Consider an example in which the product 128 detected as transacted for via the offline data transactions 124 is produce, e.g., fruits and vegetables. In this example, the app selection module 212 is more likely to output, as the selected application 214, an application 140 that specializes in produce delivery than an application that supports grocery delivery. Additionally or alternatively, the selection is based on online reviews of the retrieved applications 140, e.g., a number of online review, an average rating (on a scale from one to five) of the retrieved applications 140. Given two applications 140 that offer a same product 128, for instance, the app selection module 212 is more likely to output, as the selected application 214, the application 140 having a higher average rating and/or more online reviews.

The selected application 214 is provided to a benefit quantification module 216, which is configured to predict a quantified benefit 218 conferred on the user 118 by the user transacting for the product 128 using the selected application 214 rather than via the offline data transactions 124. In one or more implementations, the quantified benefit 218 is an estimated time savings and/or an estimated data resource (e.g., value amount and/or purchase price) savings. The benefit quantification module 216 predicts the quantified benefit 218 based on the transaction information 126 and/or sensor data, e.g., received from the sensors of the sensors 112 of the device 102.

Consider an example in which the user 118 pays an electrical utility bill at a brick-and-mortar establishment via offline data transactions 124, e.g., by traveling to the brick-and-mortar establishment, waiting in a queue, and paying the electrical utility bill once the user 118 reaches the front of the queue. In this example, the benefit quantification module 216 determines an amount of time associated with each trip to the brick-and-mortar establishment. Using GPS data of the device 102 surrounding a date and time of an offline data transaction 124 conducted at the brick-and-mortar establishment, for instance, the benefit quantification module 216 determines an amount of time from when the user 118 leaves a known location (e.g., a home address) to travel to the brick-and-mortar establishment, and when the user returns to the known location. This process is repeated over multiple trips to the brick-and-mortar establishment to determine an average time duration associated with each trip, and a frequency with which the trip is taken. Thus, the benefit quantification module 216 determines, as the quantified benefit 218, the average time duration, e.g., the average amount of time the user 118 will save each month by paying the electrical utility bill online using the selected application 214 rather than at the brick-and-mortar establishment.

In another example, the benefit quantification module 216 receives offline value data associated with the offline data transactions 124 for a product 128 from the transaction information 126, as well as online value data associated with the product 128 on the selected application 214. Further, the benefit quantification module 216 generates the quantified benefit 218 based on a difference between the offline value data and the online value data. Consider an example in which the user 118 buys dog food at a brick-and-mortar establishment. Here, the benefit quantification module 216 determines that the selected application 214 offers delivery of dog food for a price that is cheaper than the brick-and-mortar establishment. Based on the price difference and a quantity of dog food typically transacted for by the user 118 during a time period, the benefit quantification module 216 predicts value savings over the time period, e.g., the user's monthly savings by transacting for the dog food using the selected application 214 rather than at the brick-and-mortar establishment.

As shown, the quantified benefit 218 is provided to a recommendation generation module 220, which is configured to generate a recommendation 222 for the selected application 214 to be downloaded or opened on the device 102. In one or more implementations, the recommendation 222 includes an indication of the quantified benefit 218. Furthermore, the recommendation 222 includes a user interface (UI) element 224, which is selectable to open the selected application 214 or initiate a download of the selected application 214 depending on whether the selected application 214 is already downloaded on the device 102. In accordance with the described techniques, the recommendation generation module 220 outputs the recommendation 222 for display in the user interface 116 of the device 102.

In one example, the recommendation generation module 220 determines that the selected application 214 is not yet downloaded on the device 102. In this example, therefore, the UI element 224 is selectable to initiate a download of the selected application 214 on the device 102. In another example, the recommendation generation module 220 determines that the selected application 214 is already downloaded on the device 102, but has not been opened within a preceding period of time, e.g., within the last thirty days. In this example, therefore, the UI element 224 is selectable to launch the selected application 214 on the device 102. In yet another example, the recommendation generation module 220 determines that the selected application 214 or one of the applications 140 retrieved by the app retrieval module 210 is already downloaded on the device 102, and has been opened within a preceding period of time, e.g., within the last thirty days. This indicates that the user 118 is aware of an application 140 that supports online data transactions for the detected product 128, but chooses to transact for the product 128 via the offline data transactions 124. In this example, therefore, the recommendation generation module 220 refrains from displaying the recommendation 222 to the user 118.

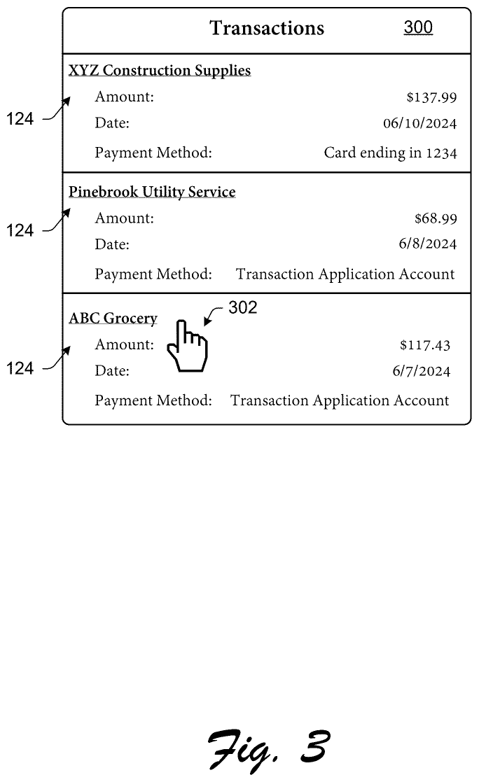

FIG. 3 depicts an example user interface 300 of a data transaction application showing records of offline data transactions. The user interface 300 is displayed on the device 102, and includes indications of offline data transactions 124. Each of the offline data transactions 124 include, by default, certain transaction information 126, such as an establishment identifier (e.g., “XYZ Construction Supplies,” “Pinebrook Utility Service,” and “ABC Grocery”), a transaction amount of the offline data transaction 124, a date of the offline data transaction 124, and a payment method of the offline data transaction 124. As shown, the payment methods include transactions conducted using the transaction application 120 (e.g., “transaction application account”) and other payment methods (e.g., “card ending in 1234”) received from a linked application of the device 102. As shown, a user input 302 is received selecting a particular offline data transaction 124 for which the user 118 wishes to enter additional transaction information 126.

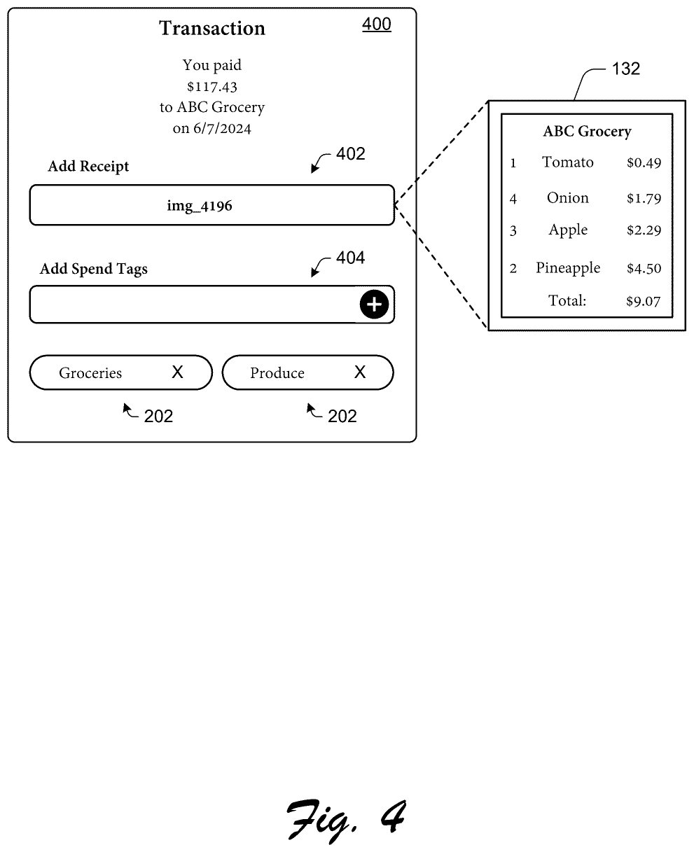

FIG. 4 depicts an example user interface 400 of a data transaction application for inputting information regarding an offline data transaction. The user interface 400 is displayed on the device 102 responsive to the user input 302. In particular, the user interface 400 includes functionality for inputting additional transaction information 126 regarding a specific offline data transaction 124 that is selected by the user input 302 of FIG. 3. For example, the user interface 400 includes a user interface element 402 that is selectable to input a transaction document image 132 associated with the offline data transaction 124. In addition, the user interface 400 includes a user interface element 404 that is selectable to input tags 202 associated with the offline data transaction, e.g., via text input to a text input field.

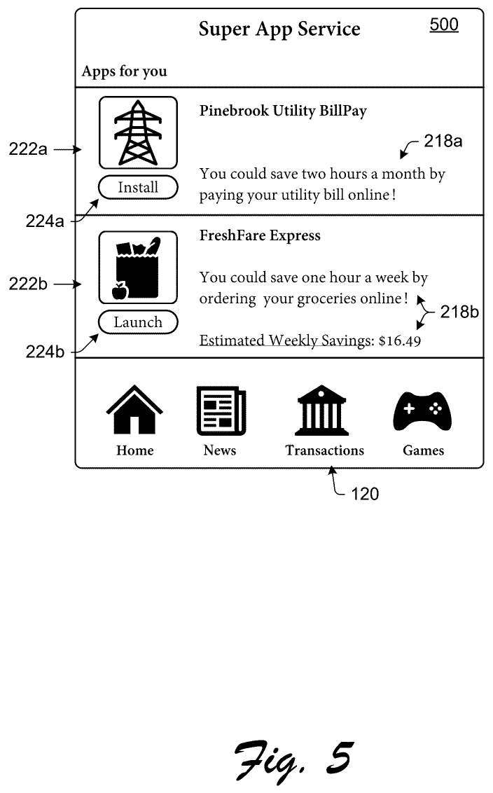

FIG. 5 depicts an example user interface 500 displaying application recommendations based on offline data transactions. As shown, the user interface 500 includes recommendations 222a, 222b to open or download applications 140 recommended by the app recommendation system 130. Moreover, the recommendations 222a, 222b include UI elements 224a, 224b that are selectable to open or download corresponding applications on the device 102. For instance, the application of the recommendation 222a is not downloaded on the device 102, and as such, the UI element 224a is selectable to download or install the application. Moreover, the application of the recommendation 222b is already downloaded on the device 102, and as such, the UI element 224b is selectable to open or launch the application.

Furthermore, the recommendations 222a, 222b include quantified benefits 218a, 218b as predicted by the benefit quantification module 216. By way of example, the recommendation 222a includes a quantified benefit 218a of an estimated time savings, while the recommendation 222b includes quantified benefits 218b of an estimated time savings and an estimated data resource (e.g., value amount) savings. Notably, the recommendations 222a, 222b are depicted as displayed within a user interface 500 of an integrated services application (e.g., a super app) that includes the transaction application 120 and other service-based applications (e.g., mini apps), such as a news application and a gaming application. However, this example is not to be construed as limiting. Rather, the recommendation 222 is displayable in a variety of ways, e.g., in a user interface of the transaction application 120, in a user interface of an application repository application (e.g., an app store), as a push notification on the device 102, and so on.

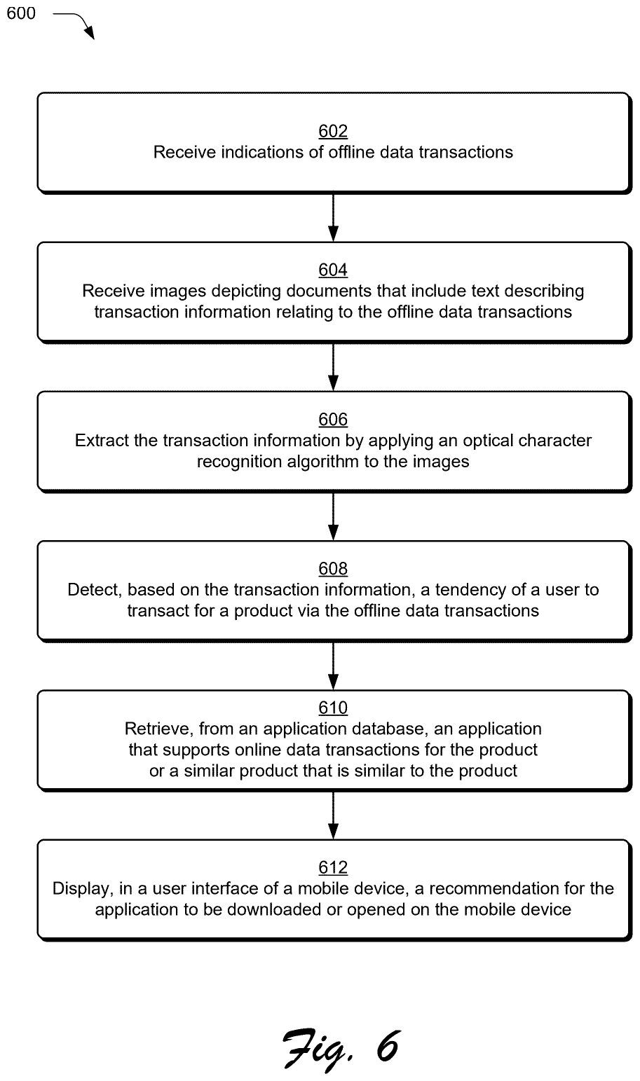

FIG. 6 illustrates a flow chart depicting an example method 600 of application recommendations based on offline data transactions in accordance with one or more implementations. Operations of the method 600 may be performed at the device 102, the service provider system 104, and/or cooperatively between the two.

At 602, indications of offline data transactions are received. By way of example, the app recommendation system 130 receives indications of offline payment transactions from the transaction application 120. A user 118, for instance, interacts with the transaction application 120 to initiate offline payment transactions for products 128, e.g., goods or services. The offline payment transactions are “offline” in the sense that the user 118 as the buyer purchases a product 128 from a seller, such that the user and a representative of the seller are present at a same physical location when the transaction is conducted. The offline payment transactions, for instance, represent offline data transactions 124 at least based on the notion that data is generated and communicated in response to initiation of the payment transaction.

At 604, images are received, and the images depict documents that include text describing transaction information relating to the offline data transactions. As part of receiving the indications of the offline data transactions 124, for instance, the app recommendation system 130 receives transaction document images 132 (e.g., payment receipts) associated with the offline data transactions 124. In at least one example, the user uploads the transaction document image 132 to a record of an offline data transaction 124 maintained by the transaction application 120. A transaction document image 132 of an offline data transaction 124 includes text describing transaction information 126, such as one or more products 128 transacted for via the offline data transaction 124, a quantity of the products 128 transacted for, and an amount of data resources (e.g., a portion of the purchase price) attributable to individual products 128 transacted for.

At 606, the transaction information is extracted by applying an optical character recognition to the images. By way of example, the image processing module 204 receives the transaction document images 132, and applies an OCR algorithm to recognize text in the transaction document images 132. Furthermore, the image processing module 204 extracts the transaction information 126 from the recognized text. To do so in one or more implementations, the image processing module 204 employs a machine learning model having been trained to detect specific components of payment receipts (e.g., transaction document images 132), such as specific products 128 transacted for, quantities of products 128 transacted for, and amounts of data resources (e.g., portions of a purchase price) attributable to individual products 128.

At 608, a tendency of a user to transact for a product via the offline data transactions is detected based on the transaction information. By way of example, the product detection module 206 detects a particular product 128 transacted for via one or more of the offline data transactions 124. Furthermore, the product detection module 206 detects a tendency 208 of the user to transact for the particular product 128 via the offline data transactions 124 based on the transaction information 126. The tendency 208 is detected as a quantity of the particular product 128 transacted for via the offline data transactions exceeding a quantity threshold, a number of the offline data transactions 124 that include the particular product 128 during a time period exceeding a frequency threshold, and/or an amount of data resources of the offline data transactions 124 attributable to (e.g., an amount of value spent on) the particular product 128 exceeding a data amount threshold, e.g., a spending threshold.

At 610, an application is retrieved from an application database that supports online data transaction for the product or a similar product that is similar to the product. By way of example, the app retrieval module 210 retrieves an application 140 from the application database 138 that supports online data transactions for the particular product 128 or a product that is similar to the particular product 128. In other words, the application 140 enables the user 118 to transact for the particular product 128 or the similar product 128 via an online transaction portal, rather than at a brick-and-mortar establishment.

At 612, a recommendation for the application to be downloaded or opened on a mobile device is displayed in a user interface of the mobile device. By way of example, the recommendation generation module 220 generates a recommendation 222 to be displayed in the user interface 116 of the device 102. The recommendation 222 includes an indication of the application 140 that supports online data transactions for the particular product 128, and a UI element 224 that is selectable to open the application 140 or initiate a download of the application 140.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 7 illustrates various components of an example device 700 in which aspects of application recommendations based on offline data transactions can be implemented. The example device 700 can be implemented as any of the devices described with reference to the previous FIGS. 1-6, such as any type of mobile device, mobile phone, mobile device, wearable device, tablet, computing, communication, entertainment, gaming, media playback, and/or other type of electronic device. For example, the device 102 and/or the service provider system 104 as shown and described with reference to FIGS. 1-6 may be implemented as the example device 700.

The device 700 includes communication transceivers 702 that enable wired and/or wireless communication of device data 704 with other devices. The device data 704 can include any of device identifying data, device location data, wireless connectivity data, and wireless protocol data. Additionally, the device data 704 can include any type of audio, video, and/or image data. Example communication transceivers 702 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 700 may also include one or more data input ports 706 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 (e.g., memory devices) that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications 714 may include the transaction application 120. The device applications 714 may also include a device manager, such as any form of a control application, software application, signal-processing and control module, code that is native to a particular device, a hardware abstraction layer for a particular device, and so on. Computer-readable storage memory 712 represents media and/or devices that enable persistent and/or non-transitory storage of information in contrast to mere signal transmission, carrier waves, or signals per se. Computer-readable storage memory 712 do not include signals per se or transitory signals.

In this example, the device 700 includes an app recommendation system 718 that implements aspects of application recommendations based on offline data transactions and may be implemented with hardware components and/or in software as one of the device applications 714. For example, the app recommendation system 718 can be implemented as the app recommendation system 130 described in detail above. In implementations, the app recommendation system 718 may include independent processing, memory, and logic components as a computing and/or electronic device integrated with the device 700.

In this example, the example device 700 also includes a camera 720 and sensors 722. The sensors, for instance, may include motion sensors such as may be implemented in an inertial measurement unit (IMU). The motion sensors can be implemented with various sensors, such as a gyroscope, an accelerometer, and/or other types of motion sensors to sense motion of the device. The various motion sensors may also be implemented as components of an inertial measurement unit in the device. Additionally or alternatively, the sensors include global positioning system (GPS) sensors for location tracking.

The device 700 also includes a wireless module 724, which is representative of functionality to perform various wireless communication tasks. The device 700 can also include one or more power sources 726, such as when the device is implemented as a mobile device. The power sources 726 may include a charging and/or power system, and can be implemented as a flexible strip battery, a rechargeable battery, a charged super-capacitor, and/or any other type of active or passive power source.

The device 700 also includes an audio and/or video processing system 728 that generates audio data for an audio system 730 and/or generates display data for a display system 732. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 734. In implementations, the audio system and/or the display system are integrated components of the example device. Alternatively, the audio system and/or the display system are external, peripheral components to the example device.

Although implementations of application recommendations based on offline data transactions have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a mobile device comprising at least one memory, and at least one processor coupled with the at least one memory and configured to cause the mobile device to receive indications of offline data transactions, the indications including transaction information relating to the offline data transactions, detect a product transacted for via the offline data transactions based on the transaction information, retrieve, from an application database, an application that supports online data transactions for the product or a similar product that is similar to the product, and display, in a user interface of the mobile device, a recommendation for the application to be downloaded or opened on the mobile device.

In some aspects, the techniques described herein relate to a mobile device, wherein the offline data transactions are payment transactions conducted between two parties at a same physical location, and the application supports online payment transactions for the product or the similar product via an online transaction portal.

In some aspects, the techniques described herein relate to a mobile device, wherein the transaction information of an offline data transaction includes one or more of an establishment associated with the offline data transaction, an indication of the product transacted for via the offline data transaction, a quantity of the product transacted for via the offline data transaction, and an amount of data resources of the offline data transaction attributable to the product.

In some aspects, the techniques described herein relate to a mobile device, wherein the at least one processor is configured to cause the mobile device to detect, based on the transaction information, a tendency to transact for the product via the offline data transactions, the tendency comprising one or more of a quantity of the product transacted for via the offline data transactions exceeding a quantity threshold, a number of the offline data transactions for the product during a time period exceeding a frequency threshold, and an amount of data resources of the offline data transactions attributable to the product exceeding a data amount threshold, and in response to the detection of the tendency, retrieve the application and display the recommendation.

In some aspects, the techniques described herein relate to a mobile device, wherein the transaction information relating to an offline data transaction includes an establishment associated with the offline data transaction, and to detect the product, the at least one processor is configured to cause the mobile device to retrieve, from an establishment database, the product that is paired with the establishment as commonly offered by the establishment.

In some aspects, the techniques described herein relate to a mobile device, wherein the indications of the offline data transactions include images depicting documents comprising text that describes the transaction information relating to the offline data transactions, and the at least one processor is configured to cause the mobile device to detect the product transacted for by applying an optical character recognition algorithm to the images.

In some aspects, the techniques described herein relate to a mobile device, wherein the at least one processor is configured to cause the mobile device to retrieve, from the application database, multiple applications that support the online data transactions for the product or the similar product, and select, from the multiple applications, the application to be displayed in association with the recommendation based on one or more of a degree of similarity between the product transacted for via the offline data transactions and products supported by the multiple applications, and online reviews of the multiple applications.

In some aspects, the techniques described herein relate to a mobile device, wherein the at least one processor is configured to cause the mobile device to determine that the application is already downloaded on the mobile device, but the application has not been opened within a preceding period of time, and display the recommendation for the application to be opened on the mobile device in response to the determination.

In some aspects, the techniques described herein relate to a mobile device, wherein the at least one processor is configured to cause the mobile device to determine that the application has not been downloaded on the mobile device, and display the recommendation for the application to be downloaded on the mobile device in response to the determination.

In some aspects, the techniques described herein relate to a mobile device, wherein the at least one processor is configured to cause the mobile device to predict a quantified benefit conferred on a user of the mobile device by the user transacting for the product or the similar product via the online data transactions using the application rather than via the offline data transactions, and display, as part of the recommendation, an indication of the quantified benefit.

In some aspects, the techniques described herein relate to a system comprising at least one memory, and at least one processor coupled with the at least one memory and configured to cause the system to receive indications of offline data transactions, receive images depicting documents that include text describing transaction information relating to the offline data transactions, detect a product transacted for via the offline data transactions by applying an optical character recognition algorithm to the images, retrieve, from an application database, an application that supports online data transactions for the product or a similar product that is similar to the product, and display, in a user interface of a mobile device, a recommendation for the application to be downloaded or opened on the mobile device.

In some aspects, the techniques described herein relate to a system, wherein the offline data transactions are payment transactions conducted between two parties at a same physical location, and the application supports online payment transactions for the product or the similar product via an online transaction portal.

In some aspects, the techniques described herein relate to a system, wherein the at least one processor is configured to cause the system to detect, based on the transaction information, a tendency to transact for the product via the offline data transactions, the tendency comprising one or more of a quantity of the product transacted for via the offline data transactions exceeding a quantity threshold, a number of the offline data transactions for the product during a time period exceeding a frequency threshold, and an amount of data resources of the offline data transactions attributable to the product exceeding a data amount threshold; and in response to the detection of the tendency, retrieve the application and display the recommendation.

In some aspects, the techniques described herein relate to a system, wherein the at least one processor is configured to cause the system to retrieve, from the application database, multiple applications that support the online data transactions for the product or the similar product, and select, from the multiple applications, the application to be displayed in association with the recommendation based on one or more of a degree of similarity between the product transacted for via the offline data transactions and products supported by the multiple applications, and online reviews of the multiple applications.

In some aspects, the techniques described herein relate to a system, wherein the at least one processor is configured to cause the mobile device to predict a quantified benefit conferred on a user of the mobile device by the user transacting for the product or the similar product via the online data transactions using the application rather than via the offline data transactions, the quantified benefit comprising one or more of an estimated time savings and an estimated data resource savings, and display, as part of the recommendation, an indication of the quantified benefit.

In some aspects, the techniques described herein relate to a method comprising receiving, by a mobile device, indications of offline data transactions, the indications including transaction information relating to the offline data transactions, detecting, by the mobile device and based on the transaction information, one or more of a quantity of a product transacted for via the offline data transactions exceeding a quantity threshold, a number of the offline data transactions for the product exceeding a frequency threshold, and an amount of data resources of the offline data transactions attributable to the product exceeding a data amount threshold, retrieving, by the mobile device and in response to the detecting, an application that supports online data transactions for the product or a similar product that is similar to the product from an application database, and displaying, in a user interface of the mobile device, a recommendation for the application to be downloaded or opened on the mobile device.

In some aspects, the techniques described herein relate to a method, wherein the offline data transactions are payment transactions conducted between two parties at a same physical location, and the application supports online payment transactions for the product or the similar product via an online transaction portal.

In some aspects, the techniques described herein relate to a method, wherein the indications of the offline data transactions include images depicting documents comprising text that describes the transaction information relating to the offline data transactions, the method further comprising detecting the product transacted for, the quantity of the product, and the amount of the data resources attributable to the product by applying an optical character recognition algorithm to the images.

In some aspects, the techniques described herein relate to a method, further comprising retrieving, from the application database, multiple applications that support the online data transactions for the product or the similar product, and selecting, from the multiple applications, the application to be displayed in association with the recommendation based on one or more of a degree of similarity between the product transacted for via the offline data transactions and products supported by the multiple applications, and online reviews of the multiple applications.

In some aspects, the techniques described herein relate to a method, further comprising predicting a quantified benefit conferred on a user of the mobile device by the user transacting for the product or the similar product via the online data transactions using the application rather than via the offline data transactions, and displaying, as part of the recommendation, an indication of the quantified benefit.

1. A mobile device comprising:
at least one memory; and
at least one processor coupled with the at least one memory and configured to cause the mobile device to:
receive indications of offline data transactions, the indications including transaction information relating to the offline data transactions;
detect a product transacted for via the offline data transactions based on the transaction information;
retrieve, from an application database, an application that supports online data transactions for the product or a similar product that is similar to the product; and
display, in a user interface of the mobile device, a recommendation for the application to be downloaded or opened on the mobile device.

2. The mobile device of claim 1, wherein the offline data transactions are payment transactions conducted between two parties at a same physical location, and the application supports online payment transactions for the product or the similar product via an online transaction portal.

3. The mobile device of claim 1, wherein the transaction information of an offline data transaction includes one or more of an establishment associated with the offline data transaction, an indication of the product transacted for via the offline data transaction, a quantity of the product transacted for via the offline data transaction, and an amount of data resources of the offline data transaction attributable to the product.

4. The mobile device of claim 1, wherein the at least one processor is configured to cause the mobile device to:
detect, based on the transaction information, a tendency to transact for the product via the offline data transactions, the tendency comprising one or more of a quantity of the product transacted for via the offline data transactions exceeding a quantity threshold, a number of the offline data transactions for the product during a time period exceeding a frequency threshold, and an amount of data resources of the offline data transactions attributable to the product exceeding a data amount threshold; and
in response to the detection of the tendency, retrieve the application and display the recommendation.

5. The mobile device of claim 1, wherein the transaction information relating to an offline data transaction includes an establishment associated with the offline data transaction, and to detect the product, the at least one processor is configured to cause the mobile device to retrieve, from an establishment database, the product that is paired with the establishment as commonly offered by the establishment.

6. The mobile device of claim 1, wherein the indications of the offline data transactions include images depicting documents comprising text that describes the transaction information relating to the offline data transactions, and the at least one processor is configured to cause the mobile device to detect the product transacted for by applying an optical character recognition algorithm to the images.

7. The mobile device of claim 1, wherein the at least one processor is configured to cause the mobile device to:
retrieve, from the application database, multiple applications that support the online data transactions for the product or the similar product; and
select, from the multiple applications, the application to be displayed in association with the recommendation based on one or more of a degree of similarity between the product transacted for via the offline data transactions and products supported by the multiple applications, and online reviews of the multiple applications.

8. The mobile device of claim 1, wherein the at least one processor is configured to cause the mobile device to:
determine that the application is already downloaded on the mobile device, but the application has not been opened within a preceding period of time; and
display the recommendation for the application to be opened on the mobile device in response to the determination.

9. The mobile device of claim 1, wherein the at least one processor is configured to cause the mobile device to:
determine that the application has not been downloaded on the mobile device; and
display the recommendation for the application to be downloaded on the mobile device in response to the determination.

10. The mobile device of claim 1, wherein the at least one processor is configured to cause the mobile device to:
predict a quantified benefit conferred on a user of the mobile device by the user transacting for the product or the similar product via the online data transactions using the application rather than via the offline data transactions; and
display, as part of the recommendation, an indication of the quantified benefit.

11. A system comprising:
at least one memory; and
at least one processor coupled with the at least one memory and configured to cause the system to:
receive indications of offline data transactions;
receive images depicting documents that include text describing transaction information relating to the offline data transactions;
detect a product transacted for via the offline data transactions by applying an optical character recognition algorithm to the images;
retrieve, from an application database, an application that supports online data transactions for the product or a similar product that is similar to the product; and
display, in a user interface of a mobile device, a recommendation for the application to be downloaded or opened on the mobile device.

12. The system of claim 11, wherein the offline data transactions are payment transactions conducted between two parties at a same physical location, and the application supports online payment transactions for the product or the similar product via an online transaction portal.

13. The system of claim 11, wherein the at least one processor is configured to cause the system to:
detect, based on the transaction information, a tendency to transact for the product via the offline data transactions, the tendency comprising one or more of a quantity of the product transacted for via the offline data transactions exceeding a quantity threshold, a number of the offline data transactions for the product during a time period exceeding a frequency threshold, and an amount of data resources of the offline data transactions attributable to the product exceeding a data amount threshold; and
in response to the detection of the tendency, retrieve the application and display the recommendation.

14. The system of claim 11, wherein the at least one processor is configured to cause the system to:
retrieve, from the application database, multiple applications that support the online data transactions for the product or the similar product; and
select, from the multiple applications, the application to be displayed in association with the recommendation based on one or more of a degree of similarity between the product transacted for via the offline data transactions and products supported by the multiple applications, and online reviews of the multiple applications.

15. The system of claim 11, wherein the at least one processor is configured to cause the mobile device to:
predict a quantified benefit conferred on a user of the mobile device by the user transacting for the product or the similar product via the online data transactions using the application rather than via the offline data transactions, the quantified benefit comprising one or more of an estimated time savings and an estimated data resource savings; and
display, as part of the recommendation, an indication of the quantified benefit.

16. A method comprising:
receiving, by a mobile device, indications of offline data transactions, the indications including transaction information relating to the offline data transactions;
detecting, by the mobile device and based on the transaction information, one or more of a quantity of a product transacted for via the offline data transactions exceeding a quantity threshold, a number of the offline data transactions for the product exceeding a frequency threshold, and an amount of data resources of the offline data transactions attributable to the product exceeding a data amount threshold;
retrieving, by the mobile device and in response to the detecting, an application that supports online data transactions for the product or a similar product that is similar to the product from an application database; and
displaying, in a user interface of the mobile device, a recommendation for the application to be downloaded or opened on the mobile device.

17. The method of claim 16, wherein the offline data transactions are payment transactions conducted between two parties at a same physical location, and the application supports online payment transactions for the product or the similar product via an online transaction portal.

18. The method of claim 16, wherein the indications of the offline data transactions include images depicting documents comprising text that describes the transaction information relating to the offline data transactions, the method further comprising detecting the product transacted for, the quantity of the product, and the amount of the data resources attributable to the product by applying an optical character recognition algorithm to the images.

19. The method of claim 16, further comprising:
retrieving, from the application database, multiple applications that support the online data transactions for the product or the similar product; and
selecting, from the multiple applications, the application to be displayed in association with the recommendation based on one or more of a degree of similarity between the product transacted for via the offline data transactions and products supported by the multiple applications, and online reviews of the multiple applications.

20. The method of claim 16, further comprising:
predicting a quantified benefit conferred on a user of the mobile device by the user transacting for the product or the similar product via the online data transactions using the application rather than via the offline data transactions; and
displaying, as part of the recommendation, an indication of the quantified benefit.
